(19) United States
(12) Patent Application Publication
(10) Pub. No.: US 2015/0123336 A1
(43) Pub. Date: May 7, 2015

(54) TENTER APPARATUS

(71) Applicant: SAMSUNG ELECTRONICS CO., LTD., SUWON-SI (KR)

(72) Inventors: Won Suk CHANG, Hwaseong-si (KR); Seoung Jin SEO, Suwon-si (KR); Chan Jae Ahn, Seoul (KR); Sung Won CHOI, Hwaseong-si (KR)

(73) Assignee: SAMSUNG ELECTRONICS CO., LTD., SUWON-SI (KR)

(21) Appl. No.: 14/251,841

(22) Filed: Apr. 14, 2014

(30) Foreign Application Priority Data
Nov. 6, 2013 (KR) 10-2013-0134396

(51) Int. Cl. D06C 3/00; B25B 5/16; B25B 5/14

(52) U.S. Cl. CPC D06C 3/00; B25B 5/145; B25B 5/163
USPC 269/268; 269/265

(57) ABSTRACT

A tenter apparatus for clipping a film includes a frame including a supporting surface supporting the film, and a clip arm which is installed to the frame and rotatable relative to the frame, clips the film along with the supporting surface of the frame and includes a plurality of first contact protrusions which is disposed at a bottom surface of the clip arm and contacts the film.

### CROSS-REFERENCE TO RELATED APPLICATION

This application claims priority to Korean Patent Application No. 10-2013-0134396 filed on Nov. 6, 2013, and all the benefits accruing therefrom under 35 U.S.C. §119, the entire contents of which are incorporated herein by reference.

### BACKGROUND

(a) Field

Embodiments of the present invention relate to a tenter apparatus which is configured to clip a film.

(b) Description of the Related Art

Various films such as a phase difference film are used in a flat display device including a liquid crystal display (“LCD”), for example. Manufacturing methods of the various films include a melt extrusion method and a solution forming method, for example. In the melt extrusion method, a polymer is melted and then extruded by an extruder to form a film, and the melt extrusion method has characteristics that productivity is high and cost is relatively low. In the solution forming method, a polymer solution including the polymer and a solvent flows to form a flexible layer on a supporting member, and then the flexible layer is processed to be returned and delaminated from the supporting member, thereby a humidified film is generated. The solvent is evaporated from the humidified film to form a film.

When manufacturing the film, a tenter apparatus clips the film by grasping the film to prevent contraction of the film to improve planarization of the film, or stretches the film in a predetermined direction to control an optical characteristic of a film clip.

### SUMMARY

When clipping a film by using a tenter apparatus and performing heat treatment, a portion of the film that contacts a clip surface of the tenter apparatus is maintained at a lower temperature compared with other portions such that the heat treatment is abnormally performed. This is because a temperature of the tenter apparatus is lower than the temperature of the heat treatment while the temperature of the tenter apparatus must be maintained at a predetermined value for a normal operation.

An embodiment provides a tenter apparatus effectively preventing a heat treatment defect of a film.

A tenter apparatus for clipping a film according to an embodiment includes a frame including a supporting surface supporting the film, and a clip arm which is installed to the frame and rotatable relative to the frame, clips the film along with the supporting surface and includes a plurality of first contact protrusions disposed at a bottom surface that contacts the film.

In an embodiment, the frame may further include a plurality of second contact protrusions disposed at the supporting surface, and the plurality of first protrusions and the plurality of second protrusions may be opposite to each other in a state in which the film is clipped.

In an embodiment, the plurality of second contact protrusions may have a shape of a hemisphere, a semi-ellipsoid, a cylinder of which one end is rounded or a partial cylinder, the plurality of second contact protrusions may be arranged in one or more columns, and the plurality of second contact protrusions may be arranged in two columns and in a zigzag shape.

In an embodiment, a height of the second contact protrusion may be higher than a thickness of the film, and may be greater than 150 micrometers (μm).

In an embodiment, the first contact protrusion may have a shape of a hemisphere, a semi-ellipsoid, a cylinder of which one end is rounded or a partial cylinder, the plurality of first contact protrusions may be arranged in one or more columns, and the plurality of first contact protrusions may be arranged in two columns and in a zigzag shape.

In an embodiment, the height of the first contact protrusion may be higher than a thickness of the film, and may be greater than 150 μm.

According to an embodiment, by disposing a plurality of contact protrusions at the portion that contacts the film of the tenter apparatus to reduce the contact area with the film, the reduction of the temperature of the film by the influence of the temperature of the tenter apparatus is reduced when performing the heat treatment, thereby effectively preventing the defect of the heat treatment.

### BRIEF DESCRIPTION OF THE DRAWINGS

The above and other embodiments, advantages and features of this disclosure will become more apparent by describing in further detail embodiments thereof with reference to the accompanying drawings, in which:

FIG. 1 is a lateral view of an embodiment of a tenter apparatus according to the present invention.

FIG. 2 is a front view of the tenter apparatus of FIG. 1.

FIGS. 3A, 3B, and 3C are bottom views of clip arms according to various embodiments of the present invention.

FIGS. 4 and 5 are perspective views of various embodiments of a tenter apparatus according to the present invention.

FIG. 6 is a graph comparing temperature distribution of a film when performing heat treatment by using a tenter apparatus according to an embodiment and temperature distribution of a film when performing heat treatment by using a conventional tenter apparatus.

### DETAILED DESCRIPTION

The present invention will be described more fully hereinafter with reference to the accompanying drawings, in which embodiments of the invention are shown. As those skilled in the art would realize, the described embodiments may be modified in various different ways, all without departing from the spirit or scope of the present invention.

It will be understood that when an element is referred to as being “on” another element, it can be directly on the other element or intervening elements may be present therebetween. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

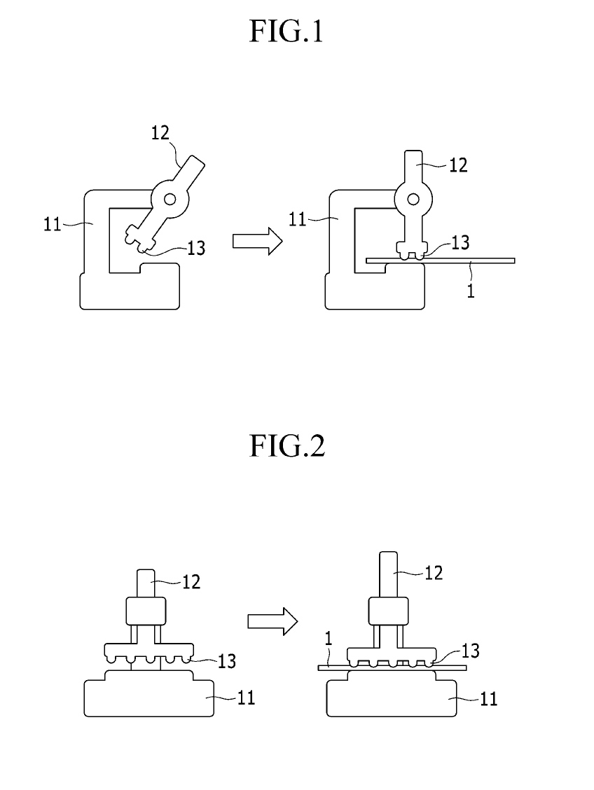

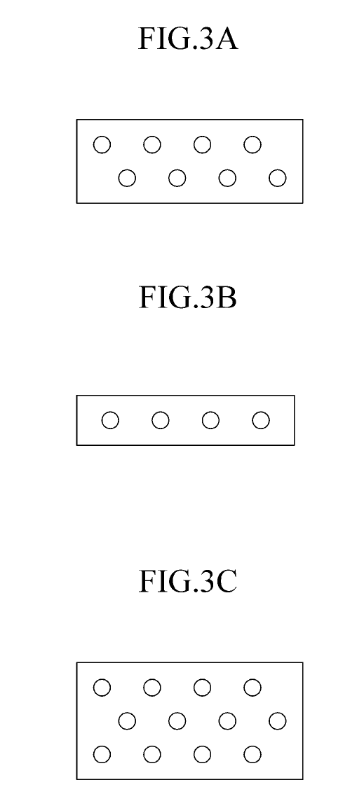

Referring to FIGS. 1 and 2, a tenter apparatus according to an embodiment will be described.

FIG. 1 is a lateral view of tenter apparatus according to an embodiment, and FIG. 2 is a front view of the tenter apparatus of FIG. 1.

A tenter apparatus according to an embodiment includes a frame 11 having an approximate “C” shape, and a clip arm 12 installed to the frame 11 and configured to be rotated. However, the invention is not limited thereto and the tenter apparatus may have various other shapes. The frame 11 provides a supporting surface on which a film 1 is mounted. The clip arm 12 is installed to be rotatable about a rotation axis with a predetermined angle with reference to the rotation axis, and a plurality of contact protrusions 13 is disposed at a bottom surface of the clip arm 12. The clip arm 12 may be rotated such that the contact protrusion 13 faces the supporting surface of the frame 11 and the film 1 is inserted and fixed between the supporting surface and the contact protrusion 13. The clip arm 12 may be rotated such that the contact protrusion 13 is farther from the supporting surface of the frame 11 and the film 1 is released from the clip state.

In embodiments, the contact protrusion 13 may have various shapes such as a hemisphere shape, a cylinder shape of which one end is rounded, and a semi-ellipsoid shape, for example, to prevent the film 1 from being damaged by the contact, and the end of the contact protrusion 13 may have a rounded shape, for example. In an embodiment, the contact protrusion 13 may have a height, which is measured from the bottom surface of the clip arm 12 to a top (e.g., distal end) of the contact protrusion 13, greater than a thickness of the clipped film 1 to prevent an entire bottom surface of the clip arm 12 from contacting the film 1 although the contact protrusion 13 is embedded in the film by the clip pressure. In an embodiment, when a polyimide film is manufactured, a thickness of the film is generally less than about 150 micrometers (μm) such that the height of the contact protrusion 13 may be greater than about 150 μm, for example.

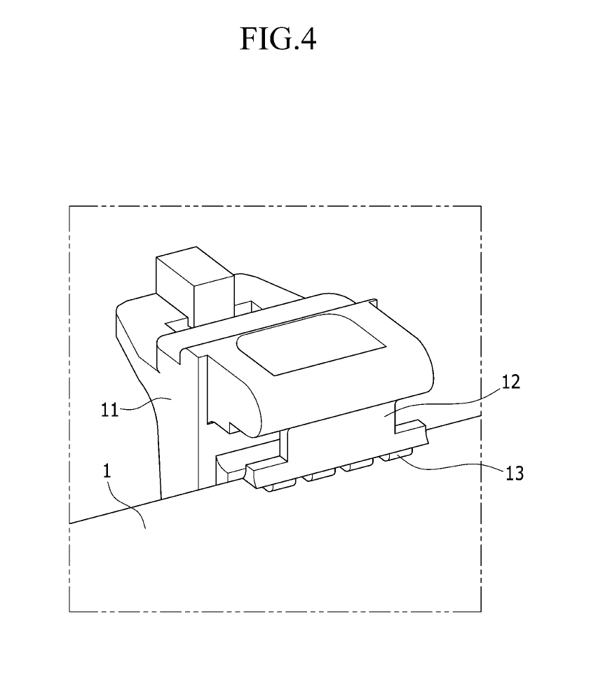

A plurality of contact protrusions 13 may be arranged with various shapes. As shown in FIG. 1, the plurality of contact protrusions 13 may be provided as two columns in parallel in a lateral view according to an edge of the film 1. However, the invention is not limited thereto, and the protrusions of two columns may be disposed in a zigzag shape (FIG. 3A), or the plurality of contact protrusions 13 may be disposed one column (FIG. 3B) or three or more columns (FIG. 3C) according to the edge of the film 1, such as in a top plan view of the device. Also, the plurality of contact protrusions 13 may be disposed with a dispersed shape without the column arrangement.

As described above, when the plurality of contact protrusion 13 is disposed at the bottom surface of the clip arm 12, an area of the clip arm 12 contacting the film 1 is reduced such that an influence of a temperature of the tenter apparatus affecting a temperature of the film 1 is reduced. Accordingly, heat lost to the tenter apparatus in the heat treatment of the film 1 may be prevented such that the heat treatment defect is not generated.

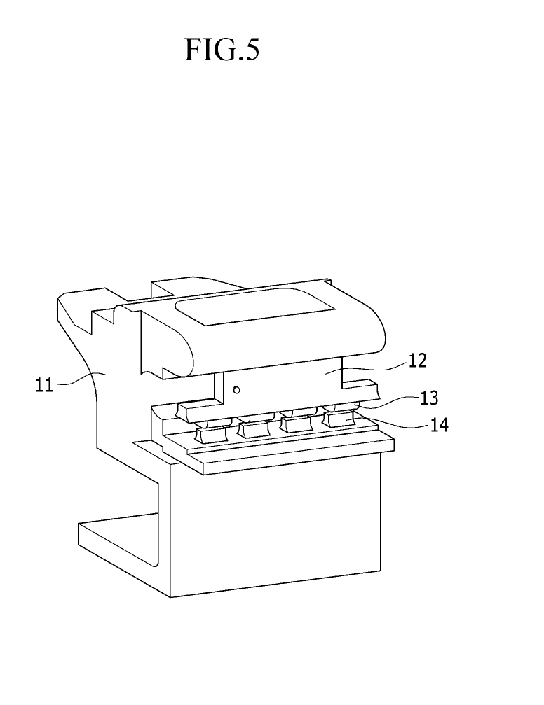

FIGS. 4 and 5 are perspective views of a tenter apparatus according to various embodiments.

In the tenter apparatus of FIG. 4, an apparatus (not shown) to drive the clip arm 12 is installed inside the frame 11, and the contact protrusion 13 has a partial cylinder shape in which the cylinder is truncated along a vertical direction in a cross section.

In the tenter apparatus of FIG. 5, compared with the tenter apparatus of FIG. 4, a contact protrusion 14 is also provided at the supporting surface of the frame 11. The contact protrusion 14 of the supporting surface may be disposed corresponding to the contact protrusion 13 of the clip arm 12. That is, when the film 1 is clipped between the contact protrusion 14 of the supporting surface and the contact protrusion 13 of the clip arm 12, the contact protrusion 14 of the supporting surface and the contact protrusion 13 of the clip arm 12 may be arranged at positions corresponding to each other such as facing each other. The contact protrusion 14 of the supporting surface may be disposed with various shapes and arrangements like the contact protrusion 13 of the clip arm 12.

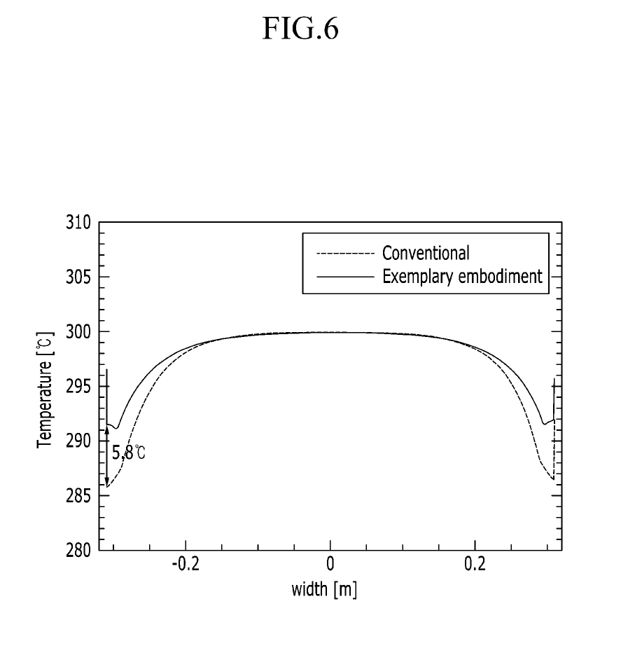

FIG. 6 is a graph comparing temperature distribution in Celsius (° C.) of a film with respect to a distance about the tenter apparatus in meters (m) when performing heat treatment by using a tenter apparatus according to an embodiment and temperature distribution of a film when performing heat treatment by using a conventional tenter apparatus.

As shown in FIG. 6, in the film in which the heat treatment is performed by using the tenter apparatus according to an embodiment, a temperature difference is substantially small between a surrounding portion that contacts the tenter apparatus and a center portion (e.g., at width 0) that does not contact the tenter apparatus, compared with the film in which the heat treatment is performed by using the conventional tenter apparatus. For example, for the film in which the heat treatment is performed by using the conventional tenter apparatus, the temperature difference is 5.8° C. larger than that for the film in which the heat treatment is performed by using the tenter apparatus according to an embodiment. This difference causes a large difference of a heat treatment result of the film. In an embodiment, when the heat treatment is performed by using the conventional tenter apparatus in manufacturing the polyimide film, an imidization ratio at the surrounding area of the film that contacts the tenter apparatus is about 40 percent (%) of an imidization ratio at the center portion of the film and the amount of the solvent that remains at the film is as large as about 15% to about 20%, and thereby a material property of the film is weak and the film may be broken when elongating the film, for example. However, when the heat treatment is performed by using the tenter apparatus according to an embodiment, the imidization ratio at the surrounding portion of the film that contacts the tenter apparatus is increased by more than about 80% of the imidization ratio at the center portion of the film, and the amount of the solvent that remains at the film is decreased by less than about 1%. Accordingly, when elongating the film, the film is not broken.

Table 1 compares a result of the case of performing the heat treatment by using the conventional tenter apparatus with a result of the case of performing the heat treatment by using the tenter apparatus according to an embodiment with regard to a contact area of the tenter apparatus and the film measured in square meter (m²), heat flux from the film to the tenter apparatus measured in watt per square meter (W/m²), and heat transfer from the film to the tenter apparatus measured in watt (W).

TABLE 1

| | Contact area (m²) | Heat flux (W/m²) | Heat transfer (W) |
|---|---|---|---|
| Conventional | 0.001867 | 49703.6 | 92.8 |
| Embodiment | 0.000333 | 10725.2 | 3.6 |

As shown in Table 1, when using the tenter apparatus according to an embodiment, a contact area of the tenter apparatus and the film may be remarkably decreased, thereby reducing an amount of heat that is lost to the tenter apparatus from the film.

While this invention has been described in connection with what is presently considered to be practical embodiments, it is to be understood that the invention is not limited to the disclosed embodiments, but, on the contrary, is intended to cover various modifications and equivalent arrangements included within the spirit and scope of the appended claims.

What is claimed is:

1. A tenter apparatus for clipping a film, comprising:
a frame including a supporting surface supporting the film; and
a clip arm which is installed to the frame and rotatable relative to the frame, clips the film along with the supporting surface of the frame and includes a plurality of first contact protrusions which is disposed at a bottom surface of the clip arm and contacts the film.

2. The tenter apparatus of claim 1, wherein
the frame further includes a plurality of second contact protrusions disposed at the supporting surface.

3. The tenter apparatus of claim 2, wherein
the plurality of first protrusions and the plurality of second protrusions are opposite to each other in a state in which the film is clipped.

4. The tenter apparatus of claim 2, wherein
the plurality of second contact protrusions has a shape of a hemisphere, a semi-ellipsoid, a cylinder of which one end is rounded or a partial cylinder.

5. The tenter apparatus of claim 2, wherein
the plurality of second contact protrusions is arranged in one or more columns.

6. The tenter apparatus of claim 5, wherein
the plurality of second contact protrusions is arranged in two columns and in a zigzag shape.

7. The tenter apparatus of claim 2, wherein
a height of the plurality of second contact protrusions is greater than a thickness of the film.

8. The tenter apparatus of claim 7, wherein
the height of the plurality of second contact protrusions is greater than about 150 micrometers.

9. The tenter apparatus of claim 1, wherein
the plurality of first contact protrusions has a shape of a hemisphere, a semi-ellipsoid, a cylinder of which one end is rounded or a partial cylinder.

10. The tenter apparatus of claim 1, wherein
the plurality of first contact protrusions is arranged in one or more columns.

11. The tenter apparatus of claim 10, wherein
the plurality of first contact protrusions is arranged in two columns and in a zigzag shape.

12. The tenter apparatus of claim 1, wherein
a height of the plurality of first contact protrusions is greater than a thickness of the film.

13. The tenter apparatus of claim 12, wherein
the height of the plurality of first contact protrusions is greater than about 150 micrometers.
